(19) United States
(12) Patent Application Publication
(10) Pub. No.: US 2024/0181714 A1
(43) Pub. Date: Jun. 6, 2024

(54) INTEGRATED OPTIMAL DESIGNING AND MANUFACTURING METHOD INVOLVING STRUCTURE LAYOUT, GEOMETRY AND 3D PRINTING

(71) Applicants: HANGZHOU CITY UNIVERSITY, Hangzhou City (CN); ZHEJIANG UNIVERSITY, Hangzhou City (CN)

(72) Inventors: Zhen Wang, Hangzhou City (CN); Jun Ye, Hangzhou City (CN); Yang Zhao, Hangzhou City (CN); Hongjia Lu, Hangzhou City (CN); Xiaoyang Lin, Hangzhou City (CN); Boqing Gao, Hangzhou City (CN); Huiping Tang, Hangzhou City (CN); Guan Quan, Hangzhou City (CN)

(21) Appl. No.: 18/354,170

(22) Filed: Jul. 18, 2023

(30) Foreign Application Priority Data
Oct. 25, 2022 (CN) 202211311119.1

(51) Int. Cl. B29C 64/393; G06F 17/11; G06F 30/20

(52) U.S. Cl. CPC B29C 64/393; G06F 17/11; G06F 30/20; B33Y 50/02

(57) ABSTRACT

An integrated optimal designing and manufacturing method involving structure layout, geometry and 3D printing is provided, the method includes: building a minimum connection base structure, establishing a layout optimization model after screening out components that violate an overhang angle constraint, adding all components to the layout optimization model in batches; considering a manufacturing constraint about an overhang angle of each component, merging the components and fusing nodes in a layout by iterative optimization, and processing crossed components; extracting structure information, building a 3D solid model, and then slicing the solid model and generating a printing path for 3D printing. Considering the overhang angle constraint of the components in the printing manufacturing, the self-supporting structure is generated optimally, and no additional support is needed in the printing process; the structure is normalized by multiple iterations of component fusion and node movement processing.

### CROSS REFERENCE TO RELATED APPLICATION

This patent application claims the priority to Chinese Patent Application No. 202211311119.1, entitled “Integrated optimal designing and manufacturing method involving structure layout, geometry and 3D printing” filed with China National Intellectual Property Administration on Oct. 25, 2022, the disclosure of which is incorporated by reference herein in its entirety.

### TECHNICAL FIELD

The disclosure relates to the technical field of structure engineering, and in particular relates to an integrated optimal designing and manufacturing method involving structure layout, geometry and 3D printing.

### BACKGROUND ART

The increasingly complex engineering requirements lead to an increasing demand for the integration of optimal designing and 3D printing of complex structures. The structure optimization includes three levels: size optimization, topology optimization, and shape optimization. Objects of the structure topology optimization include discrete structures and continuum structures. The optimization of truss-like structure systems widely used in practical engineering belongs to the discrete structure topology optimization.

For discrete structure topology optimization, the layout optimization process generally discretizes the design domain into fine grids and generates base structures, and obtains a global optimal solution of the structure layout by linear programming. However, the base structure constituted of component sets formed by connecting two mesh points leads to a huge scale of optimization matrix, resulting in a low optimization efficiency and a difficulty in implementing large-scale structure optimization. Further, results of the layout optimization are complex, and the components and nodes are complicated, thus such optimization is difficult to be applied to actual engineering.

On the basis of layout optimization, a minimum base structure is constructed by a component addition method, which can effectively reduce the scale of the initial optimization matrix and significantly improve the efficiency of solving large-scale layout optimization problems. For complex results of layout optimization, the combination of layout optimization and geometry optimization is a reasonable and effective solution; complex results of layout optimization can be effectively simplified by component fusion and node movement in the geometry optimization method. Therefore, reasonable and effective combination of structure layout and geometry optimization is an important aspect of integrated optimization of complex discrete structures.

3D printing (additive manufacturing) technology realizes free growth of the structure by accumulating materials layer by layer, thus greatly broadening flexibility of structure manufacturing. Although better theoretical results can be obtained through the combination of structure layout and geometry optimization, the overhang angle constraints should also be considered in the additive manufacturing process. Due to the influence of gravity, as an angle between a component direction and a horizontal plane decreases, the quality of manufacturing and molding will decrease accordingly; and when the angle is too small, the structure will collapse, resulting in failure of structure printing. Therefore, the overhang angle of the components in the structure, that is, the angle between the component and the horizontal direction, should be greater than a self-supporting critical angle of the printing material, and the value of the self-supporting critical angle is related to molding properties of the material itself and printing parameters.

Reasonable and effective combination of structure layout, geometry and 3D printing technology is an important factor for the integrated optimal designing and manufacturing of complex discrete structures. In order to solve the problem of self-supporting manufacturing constraints in the 3D printing process, the existing processing method is to provide support structures for the components with too small overhang angles. However, adding support structures in the 3D printing process will increase material cost and printing time, and it is difficult to remove the support structures later, which leads to failure of structure molding.

In summary, it is necessary to study an integrated optimal designing and manufacturing method involving structure layout, geometry and 3D printing, which realize the integrated designing and manufacturing based on three-axis 3D printing for discrete optimized structures such as complex truss systems.

### SUMMARY

An objective of some embodiments of the present disclosure is to overcome shortcomings in the prior art, and to provide an integrated optimal designing and manufacturing method involving structure layout, geometry and 3D printing.

The integrated optimal designing and manufacturing method involving structure layout, geometry and 3D printing includes the following steps:
S1, layout integrated optimization: first inputting constraint conditions and parameters, building a minimum connection base structure, establishing a layout optimization model after screening out components that violate an overhang angle constraint, and adding all components to the layout optimization model in batches through iterations;
S2, geometry integrated optimization: based on the result of the layout optimization, considering a manufacturing constraint about an overhang angle of each component, merging the components and fusing nodes in a layout by adopting an iterative optimization strategy, and processing crossed components to obtain an optimization result;
S3, 3D printing integrated manufacturing: extracting structure information from the optimization results, structure numerical information including a node position, a component connection and a cross-sectional size; building a 3D solid model after component assembling and node generation processing, slicing the solid model and generating a printing path for 3D printing.

Preferably, step S1 specifically includes:
S1.1, inputting design conditions and parameters: inputting a design domain size, material tensile-compressive strength, a load case and a boundary constraint, and specifying a grid density, a component length threshold of an initial base structure, a self-supporting critical angle and a molding direction in an optimization process;
S1.2,building the minimum connection base structure: performing a discretization process on a design domain by an uniform dot matrix, and connecting any two nodes to form the minimum connection base structure, where a set of components whose lengths do not exceed the component length threshold of the initial base structure is referred to as the initial base structure, and a set of components whose lengths exceed the component length threshold of the initial base structure is referred to as a potential component set;
S1.3,screening components: calculating a cosine value of an angle between a direction of each component and the molding direction, where if the cosine value of the angle is greater than a sine value of the self-supporting critical angle, the component meets the overhang angle constraint, and no additional support is added in a printing process; and screening out components that do not meet the overhang angle constraint in the initial base structure and in the potential component set;
S1.4, establishing the layout optimization model: establishing a balance matrix B between internal forces and loads of the components and a layout optimization mathematical model, and with a minimum total volume of a truss structure as an objective function, deriving the layout optimization model, where in the layout optimization model, a relative displacement of a i-th component is uᵢ, a length of the i-th component is lᵢ, and a pseudo strain

$$\frac{{u}_{i}}{{l}_{i}}$$

meets following expression (1):

$$- \frac{1}{{σ}^{-}} \leq \frac{{u}_{i}}{{l}_{i}} \leq \frac{1}{{σ}^{+}} \qquad ( 1 )$$

S1.5, component addition and iterative solution: calculating a pseudo strain of each component in the potential component set, and sorting the potential component set according to a violation degree of the pseudo strain of each component relative to a pseudo strain calculated in the expression (1); selecting K^{add} components with relatively large violation degrees from the potential component set to be added to a base structure of the layout optimization model, solving a new layout optimization model, and iteratively performing above steps for many times until all components in the potential component set are added to the layout optimization model, and the expression (1) is met.

Preferably, in step S1, for the layout optimization mathematical model, a component cross-sectional area a, a component internal force q are design variables, and balance between internal and external forces of a structure, a material ultimate strength and an area being not less than zero are constraint conditions, and expressions of the above constraint conditions are as follows:

$$\{ \begin{matrix}{Bq}_{α} = {f}_{α} \\ - {σ}^{-} a \leq {q}_{α} \leq - {σ}^{+} a \\ a \geq 0\end{matrix} \qquad ( 2 )$$

with the minimum total volume of the truss structure as a design objective, the objective function is as follows:

$${m in}_{a , q} V = {l}^{T} a , \qquad ( 3 )$$

where a=[a₁, a₂, . . . , aₘ]^{T} is a cross-sectional area of a component unit; m is a number of components; q=[q₁, q₂, . . . , qₘ]^{T} is an internal force of the component unit, tension is defined as a positive value, compression is defined as a negative value; V is a total volume of the structure of the layout optimization model; l=[l₁, l₂, . . . , lₘ]^{T} is a length of the component unit of the layout optimization model; B is a balance matrix including the direction of the component; ƒ_{α} is a node load vector; α is a serial number of working condition; and σ⁻ and σ⁺ are compressive ultimate strength and tensile ultimate strength of a material, respectively.

Preferably, in step S1, when the balance matrix B of the initial base structure cannot be solved, the component length threshold and the grid density of the initial base structure are increased to form a new initial base structure, for solving again.

Preferably, step S2 specifically includes:
S2.1, extracting the results of the layout integrated optimization: based on the result of layout integrated optimization, setting different component filtering thresholds, screening out components with too small cross-sectional areas, and merging repetitive components (i.e., component merging), as an initial solution of a geometry optimization model;
S2.2, node merging and structure simplifying: setting a node merging threshold, merging adjacent node in groups and simplifying nodes in each group to a center node of the group (i.e., node fusion);
S2.3, building the geometry optimization model: based on the layout optimization model, introducing node coordinate variables, constraining movement ranges and an overhang angle of each node, and with the minimum total volume of the truss structure as an objective function, building the geometry optimization model;
S2.4, crossed-component processing: repeating steps S2.2 to S2.3 until the optimization result meets a constraint condition definition expression (4), detecting crossings among components in the structure, forming new nodes at the crossings among the components, and dividing original components into a plurality of components according to the new nodes; and solving a geometry optimization model again for the model after the crossed-component processing, to obtain the optimization result, where if a total volume change of the structure of the model before and after optimization solution is less than a predetermined limit value, it is determined that the crossed-component processing is successful, and a new result is outputted directly, otherwise an original result is outputted.

Preferably, in step S2, for a geometry optimization mathematical model, a component cross-sectional area a, a component internal force q, and node coordinates x, y, [symbol] are design variables, and balance between internal and external forces of the structure, a material ultimate strength, a node movement range, an area being not less than zero, and an overhang angle of each node coordinate are as constraint conditions; and expressions of the above constrain conditions are as follows:

$$\{ \begin{matrix}B ( x , y , z ) {q}_{α} = {f}_{α} \\ - {σ}^{-} a \leq {q}_{α} \leq {σ}^{+} a \\ {x}^{ub} \geq x \geq {x}^{lb} \\ {y}^{ub} \geq y \geq {y}^{lb} \\ {z}^{ub} \geq z \geq {z}^{lb} \\ a \geq 0 \\ sin {θ}_{min} - \vert \frac{{X}_{i} {d}_{x}}{{l}_{x}} + \frac{{Y}_{i} {d}_{x}}{{l}_{x}} + \frac{{Z}_{i} {d}_{x}}{{l}_{x}} \vert \leq 0\end{matrix} \qquad ( 4 )$$

With a minimum total volume of the truss structure as a design objective, an objective function is as follows:

$${min V}_{x , y , z , a , q} = {l ( x , y , z )}^{T} a \qquad ( 5 )$$

where a=[a₁, a₂, . . . , aₘ]^{T} is a cross-sectional area of a component unit; m is a number of components; q=[q₁, q₂, . . . , qₘ]^{T} is an internal force of the component unit, tension is defined as a positive value, compression is defined as a negative value; V is a total volume of the structure; l=[l₁, l₂, . . . , lₘ]^{T} are lengths of the components; B is a balance matrix including a direction of each component; ƒ_{α} is a node load vector; α is a serial number of working condition; σ⁻ and σ⁺ are compressive ultimate strength and tensile ultimate strength of a material, respectively;
coordinates of nodes N₁, N₂ at both ends of an i-th component are set as N₁(x₁, y₁, z₁), N₂(x₂, y₂, z₂), Xᵢ, Yᵢ, Z₁ are projected lengths of a length lᵢ of the i-th component in directions of x, y, z axes in a Cartesian coordinate system, respectively, and Xᵢ=x₂−x₁, Yᵢ=y₂−y₁, Zᵢ=z₂−z₁, θₘᵢₙ is an initial self-supporting critical angle, dₓ, d_{y}, d_{z} are three components of a normalized molding direction vector, respectively, a molding direction is set to (0,0,1); x^{ub} and x^{lb} are upper and lower limits of a movement range of an x-coordinate of a node, respectively, y^{ub} and y^{lb}, z^{ub} and z^{lb} are similarly obtained from initial values of coordinates of the node and a grid density, and the movement range of the node does not exceed a design domain.

Preferably, in step S3, 3D modeling is performed by Rhino software, a solid model obtained by the 3D modeling is sliced by Cura software and a printing path is generated.

The beneficial effects of the present disclosure are as follows.
1) According to the integrated optimization design and manufacturing method of structure layout, geometry and 3D printing provided by the present disclosure, the overhang angle constraints of the components in the printing manufacturing are considered in each optimization process, and a self-supporting structure is generated by optimization, so that no additional support is needed in the printing process, which saves material cost and printing time, avoids the problem of difficulty in removing the support later, and realizes integrated design and manufacturing of an unsupported structure.
2) According to the integrated optimization design and manufacturing method of structure layout, geometry and 3D printing provided by the present disclosure, considering the overhang angles of components under the 3D printing manufacturing constraint, based on combination of layout integrated optimization process and geometry integrated optimization process, efficient iterative solution of a large-scale layout optimization problem is realized by the layout integrated optimization process of “component addition method”; the structure is normalized by multiple iterations of component fusion and node movement processing, effectively merging redundant components, reducing a number of nodes, and simplifying the layout optimization results in the process of geometry integrated optimization; the integrated design and manufacturing of unsupported three-axis 3D printing of discrete optimized structures such as complex truss systems are realized by 3D modeling, solid model slicing and printing path generation.

### BRIEF DESCRIPTION OF THE DRAWINGS

FIG. 1 is a specific flowchart of an integrated optimal designing and manufacturing method involving structure layout, geometry and 3D printing according to the present disclosure;

FIG. 2 is a diagram of a self-supporting critical angle test model with a horn-shaped structure;

FIG. 3A is a schematic diagram of a design domain of a vertical truss under an unidirectional central force, and FIG. 3B is a schematic diagram of a design domain of a vertical truss under bidirectional central force;

FIG. 4 shows test results of the vertical truss experiencing unidirectional central force at different support critical angles in integrated optimal designing and manufacturing involving structure layout, geometry and 3D printing;

FIG. 5 shows test results of the vertical truss experiencing bidirectional central force at different support critical angles in integrated optimal designing and manufacturing involving structure layout, geometry and 3D printing.

FIG. 6 is a block diagram of a computing device for executing and implementing an integrated optimal designing and manufacturing method involving structure layout, geometry and 3D printing according to the present disclosure.

FIG. 7 illustrates a block diagram of a computing device to implement the layout integrated optimization and geometry integrated optimization processes according to the present disclosure.

### DETAILED DESCRIPTION OF THE EMBODIMENTS

The present disclosure will be further described below in connection with embodiments. The following description of the embodiments is provided only to help understanding the present disclosure. It should be noted that for those skilled in the art, some modifications may be made to the present disclosure without departing from principles of the present disclosure, and such improvements and modifications also fall within protection scope of claims of the present disclosure.

### Embodiment 1

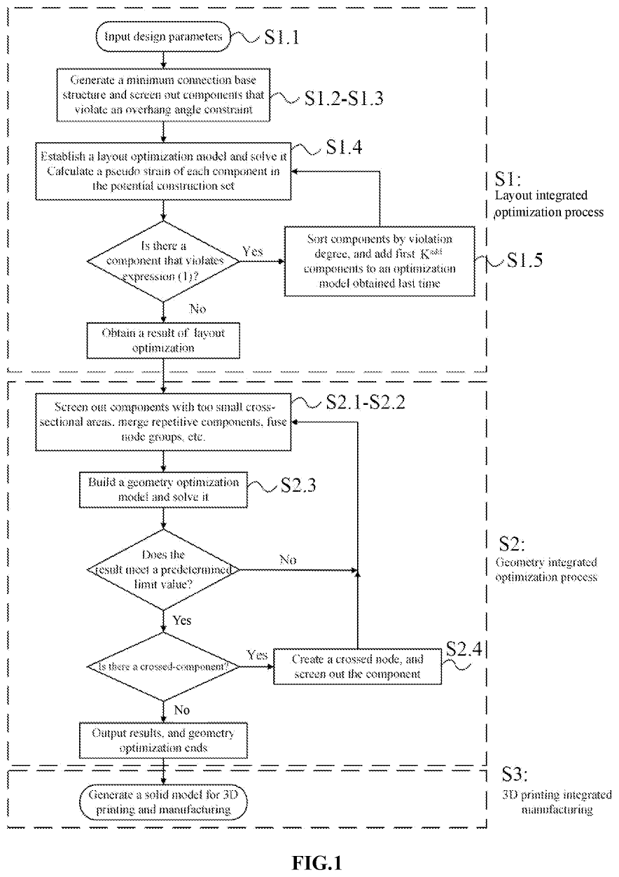

As an embodiment, as shown in FIG. 1, an integrated optimal designing and manufacturing method involving structure layout, geometry and 3D printing, specifically includes the following steps S1-S3.

In S1, layout integrated optimization is performed. The layout integrated optimization is implemented by an object-oriented Python modular algorithm framework, through firstly, inputting constraint conditions and parameters into the algorithm framework, building a minimum connection base structure, establishing a layout optimization model after screening out components that violate the overhang angle constraint, and adding all components to the layout optimization model in batches by iterations. S1 specifically includes the following steps S1.1-S1.5.

In S1.1, design conditions and parameters are inputted. Specifically, a design domain size, a material tensile-compressive strength, a load case and a boundary constraint are inputted, and a grid density, a component length threshold of an initial base structure, a self-supporting critical angle and a molding direction in the optimization process are specified.

In S1.2, a minimum connection base structure is built. Specifically, the design domain is subjected to discretization by using uniform dot matrix, and any two nodes are connected to form the minimum connection base structure, where a set of components whose lengths do not exceed the component length threshold of the initial base structure is referred to as an initial base structure, and a set of components whose lengths exceed the component length threshold of the initial base structure is referred to as a potential component set.

In S1.3, components are screened. Specifically, a cosine value of an angle between a direction of each component and the molding direction is calculated, and if the cosine value of the angle is greater than a sine value of the self-supporting critical angle, the component meets the overhang angle constraint, that is, no additional support is introduced in the printing process. The components that do not meet the overhang angle constraint in the initial base structure and in the potential component set are screened out to ensure that these components will not appear in the structure in the initial optimization and subsequent iterative optimization processes.

In S1.4, a layout optimization model is established. Specifically, the balance matrix B between an internal force and a load of the component and a layout optimization mathematical model are established, and with a minimum total volume of the truss structure as an objective function, the layout optimization model is derived. In the layout optimization mathematical model, a component cross-sectional area a, an internal force q are design variables, and a balance between internal and external forces of the structure, a material ultimate strength and an area being not less than zero are constraint conditions. Expressions of the above constraint conditions are as follows:

$$\{ \begin{matrix}{Bq}_{α} = {f}_{α} \\ - {σ}^{-} a \leq - {σ}^{+} a \\ a \geq 0\end{matrix} .$$

With a minimum total volume of the truss structure as a design objective, the

objective function is expressed as follows:

$${m in}_{a , q} V = {l}^{T} a .$$

where a=[a₁, a₂, . . . , aₘ]^{T} is a cross-sectional area of a component units; m is a number of components in the component unit; q=[q₁, q₂, . . . , qₘ]^{T} is an internal force of the component unit, and tension is defined as a positive value and compression is defined as a negative value; V is a total volume of the structure of the layout optimization model; l=[l₁, l₂, . . . , lₘ]^{T} is a length of the component unit of the layout optimization model; B is a balance matrix including the directions of the components; ƒ_{α} is a node load vector; α is a serial number of working condition; σ⁻ and σ⁺ are compressive ultimate strength and tensile ultimate strength of the material, respectively.

In the layout optimization model, a relative displacement of a i-th component is uᵢ, a length of the component is lᵢ, and a pseudo strain

$$\frac{{u}_{i}}{{l}_{i}}$$

satisfies:

$$- \frac{1}{{σ}^{-}} \leq \frac{{u}_{i}}{{l}_{i}} \leq \frac{1}{{σ}^{+}} . \qquad \# ( 1 )$$

When the balance matrix B of the initial base structure cannot be solved, the component length threshold and grid density of the initial base structure are increased to form a new initial base structure for solving again.

In S1.5, component addition and iterative solution is performed. Specifically, the pseudo strain of each component in the potential component set is calculated, and components in the potential component set are sorted according to a violation degree of the pseudo strain of each component relative to the pseudo strain requirement in step S1.4,and further, K^{add} components with relatively large violation degrees from the potential component set are selected to be added to the base structure of the layout optimization model, subsequently a new layout optimization model is solved. The above steps are performed iteratively for several times, until all the components in the potential component set are added to the layout optimization model, and the pseudo strain requirements in step S1.4 are met. In essence, the scale of the balance matrix is dynamically adjusted in the solution process, to effectively simplify the optimization problem, and improve the efficiency of linear programming solution.

In S2, geometry integrated optimization is performed. The geometry integrated optimization is implemented through the object-oriented Python modular algorithm framework. Based on the layout optimization result, considering the overhang angle of the components under manufacturing constraints, an iterative optimization strategy is adopted to merge components and fuse nodes in the layout, and process crossed components, to obtain the optimization result. S2 specifically includes the following steps S2.1-S2.4.

In S2.1, results of layout integrated optimization are extracted. Specifically, different component filtering thresholds are set based on the results of layout optimization, components with too small cross-sectional areas are screened out, and repetitive components (i.e. component merging) are merged as an initial solution of the geometry optimization model.

In S2.2, node merging and structure simplification are performed. Specifically, a node merging threshold is set, adjacent nodes are merged in groups and nodes in each group are simplified to a center point of the group (i.e. node fusion).

In S2.3, a geometry optimization model is built. Specifically, node coordinate variables are added based on the layout optimization model to build a geometry optimization model.

In the geometry optimization mathematical model, a component cross-sectional area a, a component internal force q, and node coordinates x, y, z are design variables, and the balance between internal and external forces of the structure, a material ultimate strength, a node movement range, an area being not less than zero, and overhang angles of node coordinates are constraint conditions, where for each node, the overhang angle constraints of all components connected to the node are considered, and expressions of the above constrain conditions are as follows:

$$\{ \begin{matrix}B ( x , y , z ) {q}_{α} = {f}_{α} \\ - {σ}^{-} a \leq {q}_{α} \leq {σ}^{+} a \\ {x}^{ub} \geq x \geq {x}^{lb} \\ {y}^{ub} \geq y \geq {y}^{lb} \\ {z}^{ub} \geq z \geq {z}^{lb} \\ a \geq 0 \\ sin {θ}_{min} - \vert \frac{{X}_{i} {d}_{x}}{{l}_{x}} + \frac{{Y}_{i} {d}_{x}}{{l}_{x}} + \frac{{Z}_{i} {d}_{x}}{{l}_{x}} \vert \leq 0\end{matrix} .$$

With a minimum total volume of the truss structure as a design objective, the objective function is as follows:

$${min V}_{x , y , z , a , q} = {l ( x , y , z )}^{T} a .$$

where a=[a₁, a₂, . . . , aₘ]^{T} is a cross-sectional area of a component units; m is a number of components in the component unit; q=[q₁, q₂, . . . , qₘ]^{T} is an internal force of the component unit, and a tension is defined as a positive value and a compression is defined as a negative value; V is a total volume of the structure; l=[l₁, l₂, . . . , lₘ]^{T} is a length of the component unit; B is a balance matrix including the directions of the components; ƒ_{α} is a node load vector; α is a serial number of working condition; σ⁻ and σ⁺ are compressive ultimate strength and tensile ultimate strength of the material, respectively.

Coordinates of nodes N₁, N₂ at both ends of an i-th component are set as N₁(x₁, y₁, z₁), N₂(x₂, y₂, z₂), Xᵢ, Yᵢ, Zᵢ are projected lengths of the length of the i-th component in directions of x, y, z axes in the Cartesian coordinate system, respectively. That is, Xᵢ=x₂−x₁, Yᵢ=y₂−y₁, Zᵢ=z₂−z₁. θₘᵢₙ is an initial self-supporting critical angle. dₓ, d_{y}, d_{z} are three components of the normalized molding direction vector, respectively. The molding direction is set to (0,0,1). x^{ub} and x^{lb} are upper and lower limits of a movement range of an x-coordinate of the node respectively. y^{ub} and y^{lb}, z^{ub} and z^{lb} are similarly obtained from the initial values of node coordinates and the grid density.

By limiting node movement range to the vicinity of the initial position, the geometry optimization result can be ensured to not deviate from the theoretical optimum as much as possible. The threshold of the node movement range depends on grid density. In order to ensure that the nodes do not move outside the design domain in the geometry optimization process, design domain constraints should be imposed on the nodes. Design domain constraints include design domain boundary node constraints and design domain internal node constraints. In the optimization process, nodes on the boundary can only move on the boundary through two types of constraints, and nodes inside the design domain cannot cross the design domain boundary.

For a two-dimensional design domain, two types of constraints are realized through adjusting a distance from a point to a boundary line. Similarly, through adjusting a distance from the point to a boundary surface, constraints in a three-dimensional design domain can be realized; but not all nodes require design domain constraints. Therefore, screening out the nodes that may move outside the design domain in the optimization process before imposing constraints on these nodes can reduce the number of constraints and improve optimization efficiency.

Due to mobility of the nodes in the geometry optimization process, it is desirable to impose overhang angle constraints on the node coordinates at both ends of components in the Python algorithm, so that the components obtained by connecting nodes can meet the overhang angle constraint in the optimization process to ensure that the optimization result can be printed. For each node, the overhang angle constraints of all components connected with the node are considered.

In S2.4, crossed-component processing is performed. Specifically, steps S2.2 to S2.3 are repeated until the optimization result meets a constraint condition definition formula (4), crossing among components in the structure are detected, and new nodes are generated at the crossing position of the components. The original component is into multiple components according to the new nodes. The model after the crossed-component processing is subjected to the geometry optimization model solving process, so as to obtain the optimization result. If a total volume change of the structure of the model before and after the optimization solution is less than a predetermined limit value, then it is determined that the crossed-component processing is successful, and a new result is outputted directly, otherwise the original result is outputted.

In S3, 3D-printing integrated manufacturing is performed. Specifically, structure information is extracted through the optimization result, structure numerical information includes node positions, component connections, and cross-sectional dimensions. After component assembling and node generation processing, a 3D solid model is built in Rhino software, and then the solid model is sliced by Cura software, and a printing path for 3D printing is generated.

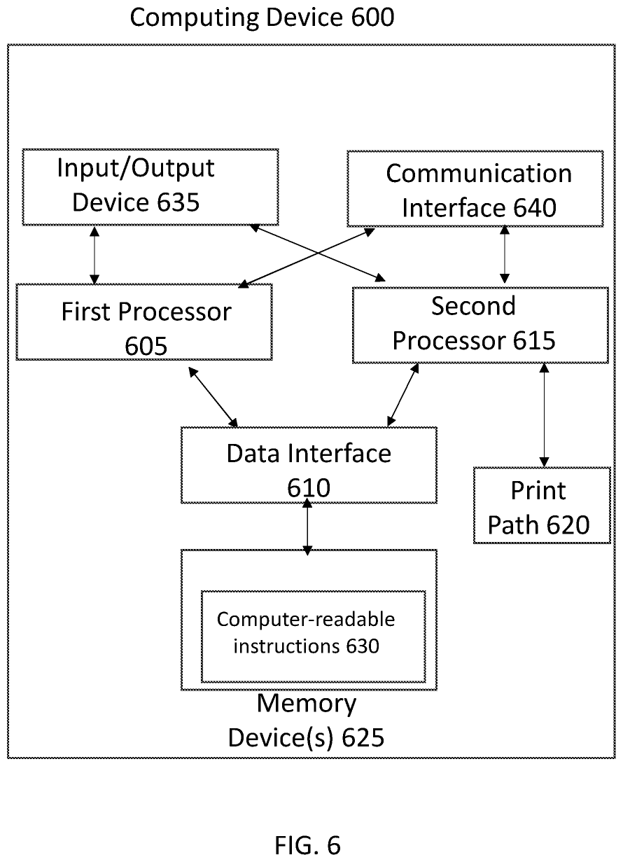

FIG. 6 is a block diagram of a computing device for executing and implementing 3D printing according to the present disclosure. In FIG. 6, in some embodiments, the computing device 600 may include a first processor 605, a data interface 610, a second processor 615, a print path 620 and one or more memory devices 625, which have computer-readable instructions 630 stored therein. In some embodiments, the first processor 605 and the second processor 610 may access computer-readable instructions 630 stored in the one or more memory devices 625 and may execute the computer-readable instructions 630 in order to perform the functions and/or features illustrated in step S3 (i.e., the method of 3D printing integrated manufacturing). In some embodiments, the computing device 600 may also include 1) a communication interface 635 which includes circuitry and devices to facilitate transmission with other computing devices and 2) an input output device 640 to communicate between internal devices (e.g., keyboard and/or processor) and/or output devices. Specifically, in some embodiments, 3D modeling is performed by 3D modeling software such as Rhino where the first processor 605 may access and execute computer-readable instructions 630 to receive data via the data interface 610 and generate a STL model format file). In some embodiments, the STL model format file is saved in the one or more memory devices 625. In some embodiments, the second processor 615 accesses and executes computer-readable instructions 630 in the one or more memory devices 625 to retrieve the STL model format file and to slice the STL model format file (by 3D printing slicing software such as Cura) , and to generate the final printing path.

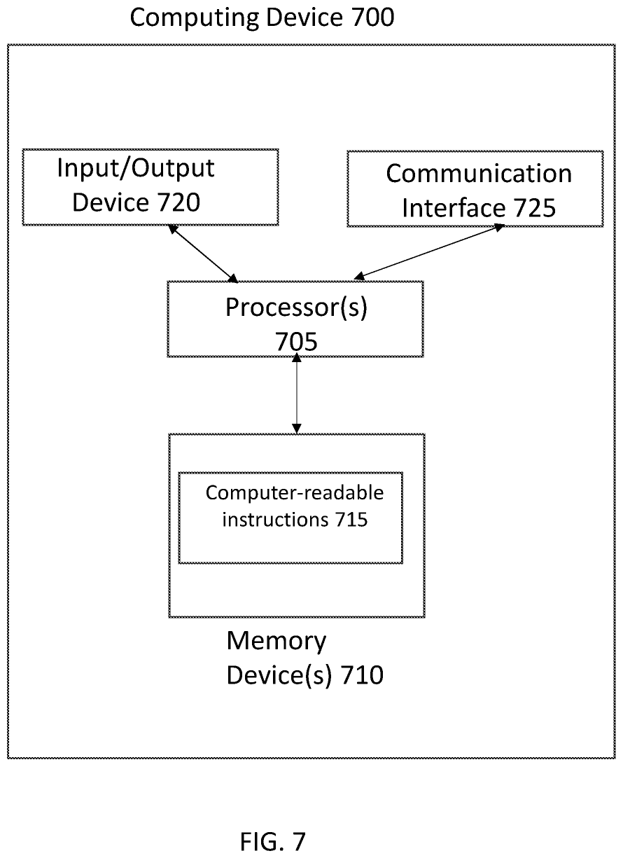

FIG. 7 illustrates a block diagram of a computing device to implement the layout integrated optimization and geometry integrated optimization processes according to the present disclosure. In FIG. 7, in some embodiments, the computing device 700 may include one or more processors 705, one or more memory devices 710 and computer-readable instructions 715 stored in the one or more memory devices 610. In some embodiments, the computing device 700 may also include 1) a communication interface 720 which includes circuitry and devices to facilitate transmission with other computing devices and 2) an input output device 725 to communicate between internal devices (e.g., keyboard and/or processor) and/or output devices. In some embodiments, the one or more processors 705 may access computer-readable instructions 715 stored in the one or more memory devices 710 and may execute the computer-readable instructions 615 in order to perform some or all of the functions and/or features illustrated in FIG. 1, including but not limited to steps S1 and S2 (e.g., the layout integrated optimization process and/or the geometry integrated optimization process).

### Embodiment 2

A method for measuring a self-supporting critical angle of a material is provided, which can provide reference data for the self-supporting critical angle of a structure in the integrated optimal designing and manufacturing method involving structure layout, geometry and 3D printing provided in Embodiment 1.

As shown in FIG. 2, by printing a horn-shaped structure using the material, the overhang angle of the horn-shaped structure gradually changes from 90° to 0° with increase of height. When the horn-shaped structure has a serious defect at a certain position, the angle between a tangent line at serious defect of the structure and the horizontal plane is measured, and a corresponding overhang angle at the serious defect is a self-supporting critical angle of the material.

In this embodiment, the self-supporting critical angle of PLA material is measured. When a printing temperature is set to 210° C. , printing test result shows that the self-supporting critical angle of the PLA material used is about 39° to 41°.

### Embodiment 3

As another embodiment, according to the integrated optimal designing and manufacturing method involving structure layout, geometry and 3D printing provided in Embodiment 1, under the manufacturing constraints of different support critical angles, optimal designing and 3D printing of the vertical truss structure with unidirectional central force are carried out.

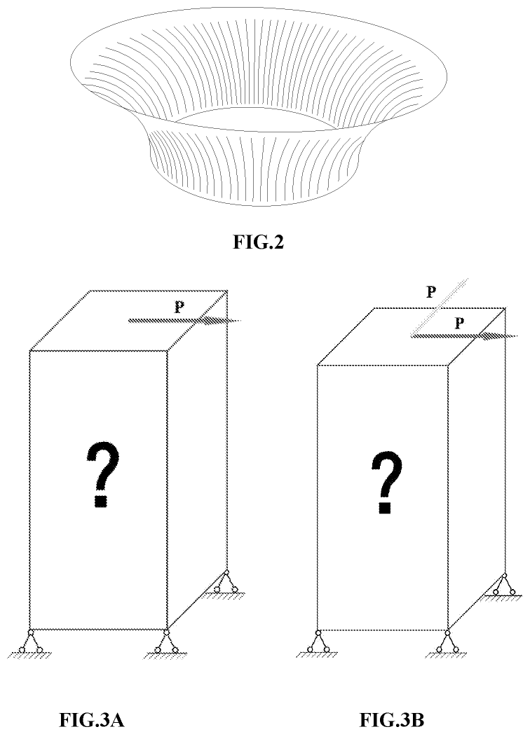

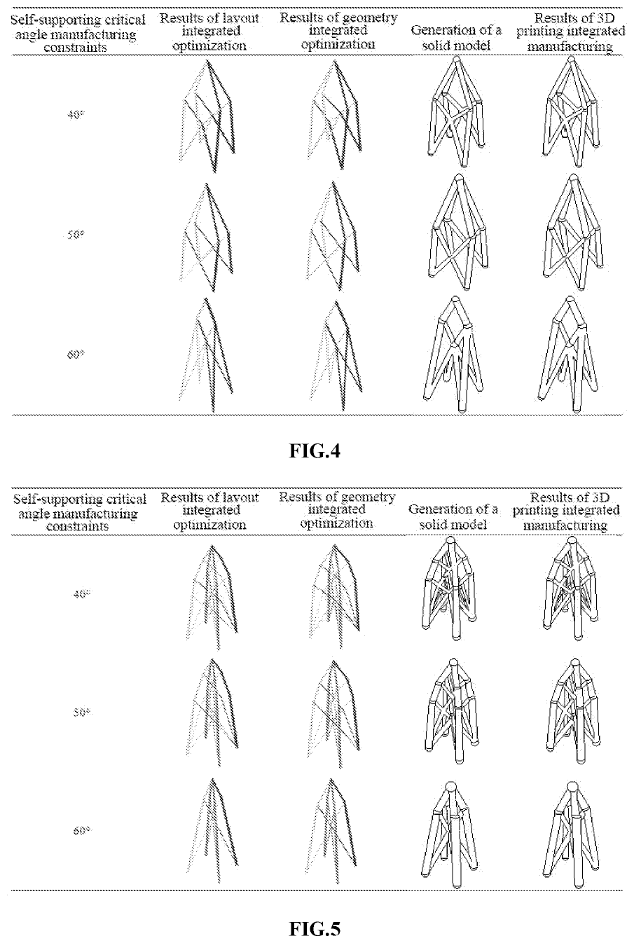

The setting of the design domain is shown, in FIG. 3A, as a cube of 4×4×10. A unidirectional unit horizontal load P acts at a center of the top of the design domain, and four corner points around the bottom of the design domain are constrained by three-way hinges. The grid density is set to 1. The tensile and compressive ultimate strengths of materials are all set to 1. Three-axis 3D printing is adopted, and the wire rod is the same PLA plastic as in Embodiment 2. The printing and molding direction is vertically upward, that is, (0, 0, 1).According to Embodiment 2, the self-supporting critical angle of the PLA plastic material obtained is 39°-41°. In this embodiment, the self-supporting critical angle parameters of the objective structure are respectively set to 40°, 50°, and 60° in the program. By comparing variation of the optimization result, the effectiveness of the optimization designing and manufacturing method under different self-supporting critical angles is verified.

The layout integrated optimization result, geometry integrated optimization result, and 3D-printing integrated manufacturing results of the structure under different self-supporting critical angles are shown in FIG. 4. In FIG. 4, a light color indicates that the component is subjecting to a tension, a dark color indicates that the component is subjecting to a compression, and a thickness of a line represents relative thickness of the component.

The optimization results of each process of the vertical truss experiencing unidirectional central force under the manufacturing constraint of different self-supporting critical angle are as follows:

| | | | | | | Volume |
|---|---|---|---|---|---|---|
| | | | | | | reduction of |
| | | | | | | geometry |
| | | | | | | integrated |
| | | | | Material | Material | optimization |
| | Self- | Volume of | Volume of | growth of | growth of | compared |
| | supporting | layout | geometry | layout | geometry | with layout |
| | critical | integrated | integrated | integrated | integrated | integrated |
| Load | angle (°) | optimization | optimization | optimization | optimization | optimization |
| Unidirectional | 0 | 43.295 | 41.956 | 0.00% | 0.00% | 3.09% |
| force | 40 | 43.500 | 43.206 | 0.47% | 2.98% | 0.68% |
| | 50 | 45.000 | 43.967 | 3.94% | 4.79% | 2.30% |
| | 60 | 48.800 | 45.911 | 12.72% | 9.43% | 5.92% |

As shown in FIG. 4, the integrated manufacturing results of 3D printing show that there is no material collapse in the printing process, that is, the optimization results can be successfully manufactured without adding supports.

According to the self-supporting critical angle of the PLA material measured in Embodiment 2, when the self-supporting critical angle is set to 40°, the maximum increase of material in the geometry integrated optimization is only 2.98%; and when the self-supporting critical angle is set to 50°, the maximum increase of the material does not exceed 5%, and 3D printing with a self-supporting critical angle beyond the inherent self-supporting critical angle of the material can still be carried out without adding an additional support structure, which verifies the effectiveness of the method of the present disclosure.

### Embodiment 4

As another embodiment, according to the integrated optimal designing and manufacturing method involving structure layout, geometry and 3D printing provided in Embodiment 1, under the manufacturing constraints of different support critical angles, optimal designing and 3D printing of the vertical truss structure with bidirectional central force are carried out.

The setting of the design domain is shown, in FIG. 3B, as a cube of 4×4×10. A bidirectional unit horizontal load P acts at a center of the top of the design domain, where the unit horizontal force in X direction is working condition 1, which is dark color, and the unit horizontal force in Y direction is working condition 2, which is light color. Corner points around the bottom of the design domain are constrained by three-way hinges. The grid density is set to 1.5, and other parameters are the same as those in Embodiment 3.

The layout integrated optimization results, geometry integrated optimization results, and 3D-printing integrated manufacturing results of the structure under different self-supporting critical angles are shown in FIG. 5. In FIG. 5, the lightest color component is tensile, and the darkest color component is compressive, and a thickness of the line represents a relative thickness of the component. And gray components with colors between the lightest color and the darkest color suffer from tension and compression under working conditions 1 and 2, respectively.

For various process, the optimization results of vertical truss experiencing bidirectional central force under manufacturing constraints of different self-supporting critical angle are as follows:

| | | | | | | Volume |
|---|---|---|---|---|---|---|
| | | | | | | reduction of |
| | | | | | | geometry |
| | | | | | | integrated |
| | | | | Material | Material | optimization |
| | Self- | Volume of | Volume of | growth of | growth of | compared |
| | supporting | layout | geometry | layout | geometry | with layout |
| | critical | integrated | integrated | integrated | integrated | integrated |
| Load | angle (°) | optimization | optimization | optimization | optimization | optimization |
| Bidirectional | 0 | 46.900 | 46.823 | 0.00% | 0.00% | 0.16% |
| force | 40 | 47.596 | 47.050 | 1.48% | 0.49% | 1.15% |
| | 50 | 48.353 | 47.878 | 3.10% | 2.25% | 0.98% |
| | 60 | 50.889 | 49.662 | 8.51% | 6.06% | 2.41% |

As shown in FIG. 5, the integrated manufacturing results of 3D printing show that there is no material collapse in the printing process, that is, for the vertical truss under bidirectional central force, the optimization results can also be successfully manufactured without adding supports.

Similarly to Embodiment 3, according to the self-supporting critical angle of the PLA material measured in Embodiment 2, when the self-supporting critical angle is set to 40°, the maximum increase of the material in the geometry integrated optimization is only 0.49%; and when the self-supporting critical angle is set to 50°, the increase of the material is 2.25%, and 3D printing with a self-supporting critical angle beyond the inherent self-supporting critical angle of the material can still be carried out without adding additional support structures.

It can be found from Embodiments 3 and 4 that integrated optimal designing and manufacturing method involving structure layout, geometry and 3D printing provided by the present disclosure solves the following problems that in complex structure designing and 3D printing, supports have to be added during printing process due to the overhang effect caused by gravity, resulting in additional material consumption and a demand of removing supports. Thus, for discrete optimization structures such as complex truss systems, the integrated designing and manufacturing based on three-axis 3D printing is realized. In the geometry integrated optimization process considering manufacturing constraint about the overhang angle of the component, redundant components are effectively merged, a number of nodes is reduced, the layout optimization results are simplified, and the structure is regularized. And through actual verification, the method of the present disclosure is effective.

What is claimed is:

1. An integrated optimal designing and manufacturing method involving structure layout, geometry and 3D printing, comprising:
S1, layout integrated optimization: first inputting constraint conditions and parameters, building a minimum connection base structure, establishing a layout optimization model after screening out components that violate an overhang angle constraint, and adding all components to the layout optimization model in batches through iterations;
S2, geometry integrated optimization: based on result of the layout integrated optimization, considering a manufacturing constraint about an overhang angle of each component, merging the components and fusing nodes in a layout by adopting an iterative optimization strategy, and processing crossed components to an obtain optimization result;
S3, 3D printing integrated manufacturing: extracting structure information from the optimization results, structure numerical information comprising a node position, a component connection and a cross-sectional size; building a 3D solid model after component assembling and node generation processing, slicing the solid model and generating a printing path for 3D printing.

2. The method according to 1, wherein step S1 comprises:
S1.1, inputting design conditions and parameters: inputting a design domain size, material tensile-compressive strength, a load case and a boundary constraint, and specifying a grid density, a component length threshold of an initial base structure, a self-supporting critical angle and a molding direction in an optimization process;
S1.2, building the minimum connection base structure: performing a discretization process on a design domain by an uniform dot matrix, and connecting any two nodes to form the minimum connection base structure, wherein a set of components whose lengths do not exceed the component length threshold of the initial base structure is referred to as the initial base structure, and a set of components whose lengths exceed the component length threshold of the initial base structure is referred to as a potential component set;
S1.3, screening components: calculating a cosine value of an angle between a direction of each component and the molding direction, wherein if the cosine value of the angle is greater than a sine value of the self-supporting critical angle, the component meets the overhang angle constraint, and no additional support is added in a printing process; and screening out components that do not meet the overhang angle constraint in the initial base structure and in the potential component set;
S1.4, establishing the layout optimization model: establishing a balance matrix B between internal forces and loads of the components and a layout optimization mathematical model, and with a minimum total volume of a truss structure as an objective function, deriving the layout optimization model, wherein in the layout optimization model, a relative displacement of a i-th component is uᵢ, a length of the i-th component is lᵢ, and a pseudo strain
$$\frac{{u}_{i}}{{l}_{i}}$$
meets following expression (1):
$$- \frac{1}{{σ}^{-}} \leq \frac{{u}_{i}}{{l}_{i}} \leq \frac{1}{{σ}^{+}} . \qquad ( 1 )$$
S1.5, component addition and iterative solution: calculating a pseudo strain of each component in the potential component set, and sorting the potential component set according to a violation degree of the pseudo strain of each component relative to a pseudo strain calculated in the expression (1); selecting K^{add} components with relatively large violation degrees from the potential component set to be added to a base structure of the layout optimization model, solving a new layout optimization model, and iteratively performing above steps for many times until all components in the potential component set are added to the layout optimization model, and the expression (1) is met.

3. The method according to 2, wherein in step S1, for the layout optimization mathematical model, a component cross-sectional area a, a component internal force q are design variables, and balance between internal and external forces of a structure, a material ultimate strength and an area being not less than zero are constraint conditions, and expressions of the above constraint conditions are as follows:
$$\{ \begin{matrix}{Bq}_{α} = {f}_{α} \\ - {σ}^{-} a \leq - {σ}^{+} a \\ a \geq 0\end{matrix} ; \qquad ( 2 )$$
with the minimum total volume of the truss structure as a design objective, the objective function is as follows:
$${m in}_{a , q} V = {l}^{T} a ; \qquad ( 3 )$$
wherein a=[a₁, a₂, . . . , aₘ]^{T} is a cross-sectional area of a component unit; m is a number of components; q=[q₁, q₂, . . . , qₘ]^{T} is an internal force of the component unit, tension is defined as a positive value, compression is defined as a negative value; V is a total volume of the structure of the layout optimization model; l=[l₁, l₂, . . . , lₘ]^{T} is a length of the component unit of the layout optimization model; B is a balance matrix comprising the direction of the component; ƒ_{α} is a node load vector; α is a serial number of working condition; and σ⁻and σ⁺ are compressive ultimate strength and tensile ultimate strength of a material, respectively.

4. The method according to 2, wherein in step S1, when the balance matrix B of the initial base structure cannot be solved, the component length threshold and the grid density of the initial base structure are increased to form a new initial base structure, for solving again.

5. The method according to 1, wherein step S2 comprises:
S2.1, extracting the result of the layout integrated optimization: based on the result of layout integrated optimization, setting different component filtering thresholds, screening out components with too small cross-sectional areas, and merging repetitive components, as an initial solution of a geometry optimization model;
S2.2, node merging and structure simplifying: setting a node merging threshold, merging adjacent node in groups and simplifying nodes in each group to a center point of the group;
S2.3, building the geometry optimization model: based on the layout optimization model, introducing node coordinate variables, constraining a movement range and an overhang angle of each node, and with the minimum total volume of the truss structure as an objective function, building the geometry optimization model;
S2.4, crossed-component processing: repeating steps S2.2 to S2.3 until the optimization result meets a constraint condition definition expression (4), detecting crossings among components in the structure, forming new nodes at the crossings among the components, and dividing original components into a plurality of components according to the new nodes; and solving a geometry optimization model again for the model after the crossed-component processing, to obtain the optimization result, wherein if a total volume change of the structure of the model before and after optimization solution is less than a predetermined limit value, it is determined that the crossed-component processing is successful, and a new result is outputted directly, otherwise an original result is outputted.

6. The method according to 5, wherein in step S2, for a geometry optimization mathematical model, a component cross-sectional area a, a component internal force q, and node coordinates x, y, [symbol] are design variables, and balance between internal and external forces of the structure, a material ultimate strength, a node movement range, an area being not less than zero, and an overhang angle of each node coordinate are constraint conditions; and expressions of the above constrain conditions are as follows:
$$\{ \begin{matrix}B ( x , y , z ) {q}_{α} = {f}_{α} \\ - {σ}^{-} a \leq {q}_{α} \leq {σ}^{+} a \\ {x}^{ub} \geq x \geq {x}^{lb} \\ {y}^{ub} \geq y \geq {y}^{lb} \\ {z}^{ub} \geq z \geq {z}^{lb} \\ a \geq 0 \\ sin {θ}_{min} - \vert \frac{{X}_{i} {d}_{x}}{{l}_{x}} + \frac{{Y}_{i} {d}_{x}}{{l}_{x}} + \frac{{Z}_{i} {d}_{x}}{{l}_{x}} \vert \leq 0\end{matrix} ; \qquad ( 4 )$$
with a minimum total volume of the truss structure as a design objective, an objective function is as follows:
$${min V}_{x , y , z , a , q} = {l ( x , y , z )}^{T} a ; \qquad ( 5 )$$
wherein a=[a₁, a₂, . . . , aₘ]^{T} is a cross-sectional area of a component unit; m is a number of components; q=[q₁, q₂, . . . , qₘ]^{T} is an internal force of the component units, tension is defined as a positive value, compression is defined as a negative value; V is a total volume of the structure; l=[l₁, l₂, . . . , lₘ]^{T} is a length of the component unit; B is a balance matrix comprising a direction of each component; ƒ_{α} is a node load vector; α is a serial number of working condition; σ⁻ and σ⁺ are compressive ultimate strength and tensile ultimate strength of a material respectively;
coordinates of nodes N₁, N₂ at both ends of an i-th component are set as N₁(x₁, y₁, z₁), N₂(x₂, y₂, z₂), Xᵢ, Yᵢ, Zᵢ are projected lengths of a length lᵢ of the i-th component in directions of x, y, z axes in a Cartesian coordinate system, respectively, and Xᵢ=x₂−x₁, Yᵢ=y₂−y₁, Zᵢ=z₂−z₁, θₘᵢₙ is an initial self-supporting critical angle, dₓ, d_{y}, d_{z} are three components of a normalized molding direction vector, respectively, a molding direction is set to (0,0,1); x^{ub} and x^{lb} are upper and lower limits of a movement range of an x-coordinate of a node, respectively y^{ub} and y^{lb}, z^{ub} and z^{lb} are similarly obtained from initial values of coordinates of the node and a grid density, and the movement range of the node does not exceed a design domain.

7. The method according to 1, wherein in step S3, 3D modeling is performed by Rhino software, a solid model obtained by the 3D modeling is sliced by Cura software and a printing path is generated.
